(19) United States
(12) Patent Application Publication
(10) Pub. No.: US 2017/0333934 A1
(43) Pub. Date: Nov. 23, 2017

(54) MASKING PLUG FOR COLD SPRAY REPAIR AT COUNTERBORE HOLE

(71) Applicant: SIKORSKY AIRCRAFT CORPORATION, Stratford, CT (US)

(72) Inventor: Young Hanh Le Do, Westport, CT (US)

(21) Appl. No.: 15/525,446

(22) PCT Filed: Oct. 28, 2015
(86) PCT No.: PCT/US15/57694

§ 371 Date: May 9, 2017

Related U.S. Application Data
(60) Provisional application No. 62/078,159, filed on Nov. 11, 2014.

(51) Int. Cl. B05B 15/04; B05D 3/12; C23C 24/04; B64F 5/40; C23C 4/06; F16H 57/032; F16H 57/02

(52) U.S. Cl. CPC B05B 15/0462; C23C 4/06; B05D 3/12; F16H 57/032; C23C 24/04; B64F 5/40; B23P 2700/06; F16H 2057/02043

(57) ABSTRACT

A method of improving a structure of a component adjacent a feature is provided including removing a portion of the structure including at least one area where damage of corrosion has occurred or is likely to occur to expose a surface of the structure. A masking plug is installed into the feature such that a base of the masking plug is coupled to a first portion of the feature and a head of the masking plug is arranged adjacent a second portion of the feature. A structural deposit is formed on the surface and is integral with the structure. Excess material of the structural deposit and a portion of the head of the masking plug is removed. The second portion of the feature is reformed and the masking plug is removed from the feature.

### CROSS-REFERENCE TO RELATED APPLICATION

This application claims the benefit of U.S. provisional patent application Ser. No. 62/078,159 filed Nov. 11, 2014, the entire contents of which are incorporated herein by reference.

### BACKGROUND OF THE INVENTION

Exemplary embodiments of the invention relate to components of a rotary-wing aircraft susceptible to corrosion damage and, more particularly, to a method for preventing or repairing corrosion damage to such a component of a rotary-wing aircraft.

A rotary-wing aircraft includes components, such as a gearbox or transmission housing for example, typically constructed from aluminum and magnesium alloys. As a result of exposure of such components to the environment, these alloy materials are susceptible to both general corrosion and galvanic corrosion. For example, the presence of water or moisture on the outer surface of the component may cause corrosion and other environmental conditions, such as chemical fallout and saltwater for example, may exacerbate corrosion. Alternatively, electro-chemical incompatibility with adjacent components can lead to galvanic corrosion. Both corrosion modes cause the material of the component to deteriorate, thereby reducing the cross-section thickness thereof. In some instances, the component's effective cross-section may be excessively reduced such that the structural integrity of the component is compromised.

Conventional rotary-wing aircraft component repair methods allow for dimensional restoration of aluminum and magnesium structures using a variety of techniques including, but not limited to, epoxy bonding, plasma spray, high velocity oxygen fuel (HVOF) thermal spray and fusion welding for example. More recently, deposition techniques, such as cold spray deposition for example, are being used to restore damaged structures. When such methods are used to rebuild a damaged structure adjacent a feature, such as a counterbore for example, the feature must be masked prior to the deposition. Due to the geometry of the feature and the adjacent structure being repaired, conventional masking processes are often inadequate. For example, depending on the material and the geometry of the masking selected, the deposition particles may deflect and create pits in the structure. In addition, if the masking material is the same as the deposited material, the deposited particles will weld to the mask making it difficult to remove from the structure.

### BRIEF DESCRIPTION OF THE INVENTION

According to one embodiment of the invention, a method of improving a structure of a component adjacent a feature is provided including removing a portion of the structure including at least one area where damage of corrosion has occurred or is likely to occur to expose a surface of the structure. A masking plug is installed into the feature such that a base of the masking plug is coupled to a first portion of the feature and a head of the masking plug is arranged adjacent a second portion of the feature. A structural deposit is formed on the surface and is integral with the structure. Excess material of the structural deposit and a portion of the head of the masking plug is removed to expose an internal locating hole formed therein. The second portion of the feature is reformed and the masking plug is removed from the feature.

In addition to one or more of the features described above, or as an alternative, in further embodiments an internal locating hole is exposed when removing excess material of the structural deposit and a portion of the head of the masking plug

In addition to one or more of the features described above, or as an alternative, in further embodiments the structural deposit includes one or more layers of powdered material applied to the area through a cold spray deposition process.

In addition to one or more of the features described above, or as an alternative, in further embodiments the feature is a counterbore hole such that the first portion of the counterbore hole is a hole and the second portion of the counterbore hole is a counterbore.

In addition to one or more of the features described above, or as an alternative, in further embodiments the component is a power transmission housing of a rotary wing aircraft.

In addition to one or more of the features described above, or as an alternative, in further embodiments excess material is removed to achieve a desired dimension of the component.

In addition to one or more of the features described above, or as an alternative, in further embodiments during reforming of the second portion of the feature, the head of the masking plug is removed.

In addition to one or more of the features described above, or as an alternative, in further embodiments a tool may be coupled to a portion of the internal locating hole to remove the plug from the feature.

A plug for masking a feature of a component during a deposition process is provided including a base and a head connected by a neck. The base is configured to threadably couple to a first portion of the feature. The head has a diameter smaller than a major diameter of a second portion of the feature. A locating hole extends from an interior of the base to the head. The locating hole is configured to identify a location of the feature within a desired degree of concentricity.

In addition to one or more of the features described above, or as an alternative, in further embodiments the feature is a counterbore hole such that the first portion of the counterbore hole is a hole and the second portion of the counterbore hole is a counterbore.

In addition to one or more of the features described above, or as an alternative, in further embodiments the base is configured to threadably couple to the first portion of the feature.

In addition to one or more of the features described above, or as an alternative, in further embodiments wherein a maximum diameter of the head is larger than a diameter of the base.

In addition to one or more of the features described above, or as an alternative, in further embodiments a groove is formed in a free end of the head, the groove being generally complementary to a tool configured to install the plug into the feature.

In addition to one or more of the features described above, or as an alternative, in further embodiments the locating hole includes a first portion arranged within at least the base, and a second portion arranged within the head, the first portion having a plurality of threads.

In addition to one or more of the features described above, or as an alternative, in further embodiments the head is shaped to minimize interference with an adjacently formed structural deposit during the deposition process.

According to another embodiment of the invention, a plug for masking a feature of a component during a deposition process is provided including a base configured to threadably couple to a portion of the feature. A head connected to the base has a diameter different than the base. A removal hole is positioned within an interior of the masking plug and extends from the base over only a portion of a height of the plug. The removal hole has a plurality of threads accessible to decouple the base form the portion of the feature formation of after a structural deposit.

In addition to one or more of the features described above, or as an alternative, in further embodiments the shaft is cylindrical or conical.

In addition to one or more of the features described above, or as an alternative, in further embodiments a groove is formed in the top end of the shaft, the groove being generally complementary to a tool configured to install the plug into the feature.

In addition to one or more of the features described above, or as an alternative, the plurality of threads of the removal hole positioned within the interior of the masking plug are oriented in a direction opposite a plurality of threads coupling the base to the portion of the feature.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an exemplary rotary wing aircraft;

FIGS. 2a and 2b are exemplary schematic diagrams of the main rotor system and the tail rotor system of the aircraft of FIG. 1;

FIG. 3 is a perspective view of a gearbox housing of a rotary wing aircraft according to an embodiment of the invention;

FIG. 4 is a cross-sectional view of a masking plug configured for use with a counter bore or counter sink hole according to an embodiment of the invention;

FIG. 5a is a cross-sectional view of a countersink hole of a transmission housing having areas of corrosion or damage according to an embodiment of the invention;

FIG. 5b is a cross-sectional view of the countersink hole of FIG. 5a wherein the areas of corrosion or damage have been removed according to an embodiment of the invention;

FIG. 6 is a cross-sectional view of the countersink hole of FIG. 5b having a masking plug installed therein according to an embodiment of the invention;

FIG. 6a is a detailed view of the countersink hole of FIG. 6 according to an embodiment of the invention;

FIG. 7 is a cross-sectional view of the countersink hole of FIG. 6 having a structural deposit formed there around and a portion of the mask removed according to an embodiment of the invention;

FIG. 8 is a cross-sectional view of the countersink hole of FIG. 7 wherein a portion of the structural deposit and the masking plug has been machined away to redefine the countersink according to an embodiment of the invention;

FIG. 9 is a method for forming a structural deposit on a structure adjacent a countersink or counterbore hole according to an embodiment of the invention.

FIG. 10 is a cross-sectional view of a masking plug configured for use with a threaded hole according to an embodiment of the invention;

FIG. 11a is a cross-sectional view of a countersink hole of a transmission housing having areas of corrosion or damage according to an embodiment of the invention;

FIG. 11b is a cross-sectional view of the countersink hole of FIG. 11a wherein the areas of corrosion or damage have been removed according to an embodiment of the invention;

FIG. 12 is a cross-sectional view of the countersink hole of FIG. 11b having a masking plug installed therein according to an embodiment of the invention;

FIG. 13 is a cross-sectional view of the countersink hole of FIG. 12 having a structural deposit formed on top of the masking plug according to an embodiment of the invention;

FIG. 14 is a cross-sectional view of the countersink hole of FIG. 13 wherein a portion of the structural deposit has been machined away to redefine the countersink according to an embodiment of the invention; and

FIG. 15 is a method for forming a structural deposit on a structure adjacent a countersink or counterbore hole according to an embodiment of the invention.

The detailed description explains embodiments of the invention, together with advantages and features, by way of example with reference to the drawings.

### DETAILED DESCRIPTION OF THE INVENTION

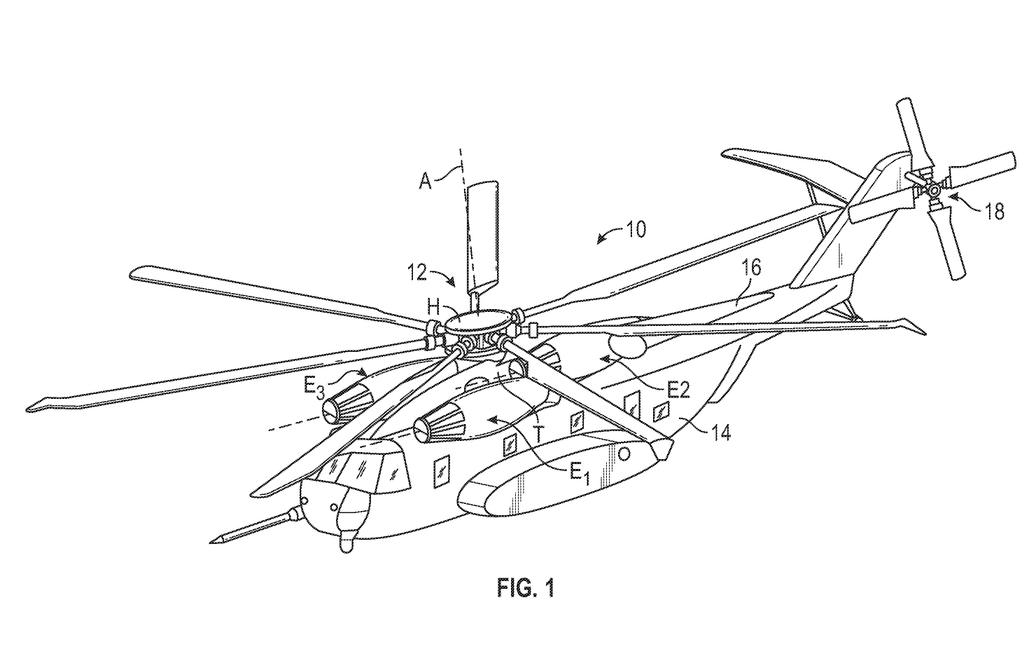

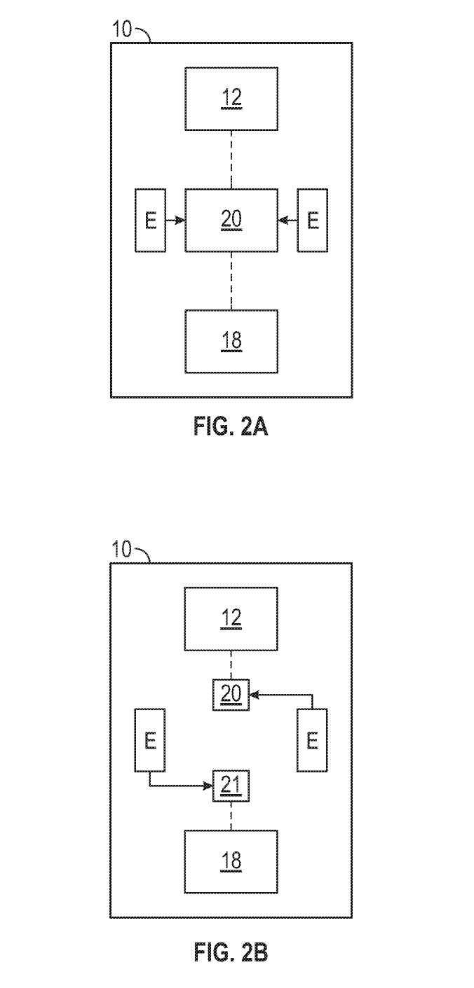

FIG. 1 schematically illustrates a rotary-wing aircraft 10 having a main rotor system 12. The aircraft 10 includes an airframe 14 having an extending tail 16 which mounts a tail rotor system 18, such as an anti-torque system, a translational thrust system, a pusher propeller, or a rotor propulsion system for example. Power is transferred from one or more engines E to a power transmission gearbox 20 (see FIGS. 2a and 2b), to drive the main rotor system 12 about a respective axis of rotation A. Although a particular rotary wing aircraft configuration is illustrated and described in the disclosed embodiment, other configurations and/or machines, such as a high speed compound rotary wing aircraft with supplemental translational thrust systems, a dual contra-rotating, coaxial rotor system aircraft, and a turbo-prop, tilt-rotor or tilt-wing aircraft for example, will also benefit from the present invention.

Referring now to FIG. 2a, a schematic diagram of the main rotor system 12 and the tail rotor system 18 of the aircraft 10 of FIG. 1 is provided in more detail. In the illustrated non-limiting embodiment, the power transmission gearbox 20 is interposed between one or more engines E, the main rotor system 12 and the tail rotor system 18. The gearbox 20 may be mechanically connected to and configured to operate both the main rotor system 12 and the tail rotor system 18. In another embodiment, shown in FIG. 2b, the rotary wing aircraft 10 includes a first power transmission gearbox 20 mechanically coupled to and configured to operate the main rotor system 12. Similarly, a second power transmission gearbox 21 is mechanically connected to and configured to operate the tail rotor system 18. Each of the power transmission gearboxes 20, 21 receives power from at least one engine E of the aircraft 10.

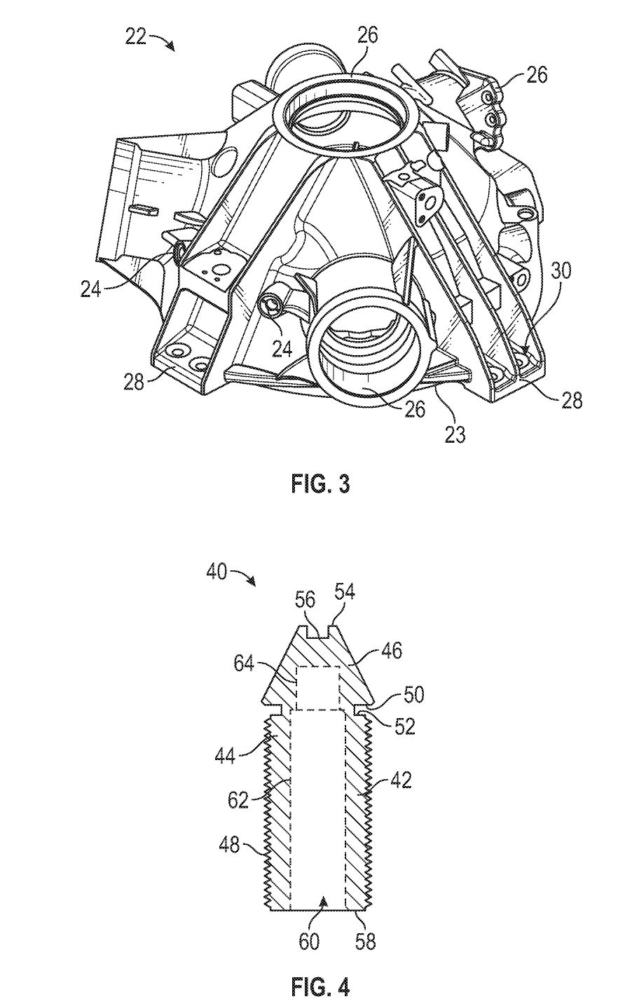

Referring now to FIG. 3, the power transmission gearbox 20, 21 is generally mounted within a housing 22 configured to support the gear-train therein. In one embodiment, the housing 22 includes a magnesium material. However, other materials, such as aluminum for example, are within the scope of the invention. The illustrated, non-limiting embodiment of a housing 22 generally includes a plurality of first openings 24 configured to provide a plurality of passageways for a lubricant to various portions of the gearbox 20. The housing 22 may also include a plurality of second openings 26 configured to at least partially support an input module attachment (not shown), such as the rotor shaft (not shown) of the main rotor system 12 or the tail rotor system 18 for example. In addition, the housing 22 may include a plurality of mounting feet 28 arranged about the periphery thereof near a first end 23. Although a particular transmission housing 22 configuration is illustrated and described in the disclosed non-limiting embodiment, other configurations are within the scope of the invention.

The portions of the housing 22 that are most susceptible to damage, as well as corrosion and pitting, are generally the areas adjacent to or configured to contact or engage another component and/or a material distinguishable from the material of the housing 22. Exemplary areas include the end 23 of the housing 22 having one or more counterbore or countersink holes 30 formed therein for example. However, other surfaces and areas of the housing 22 as well as other components are similarly susceptible to corrosion and damage.

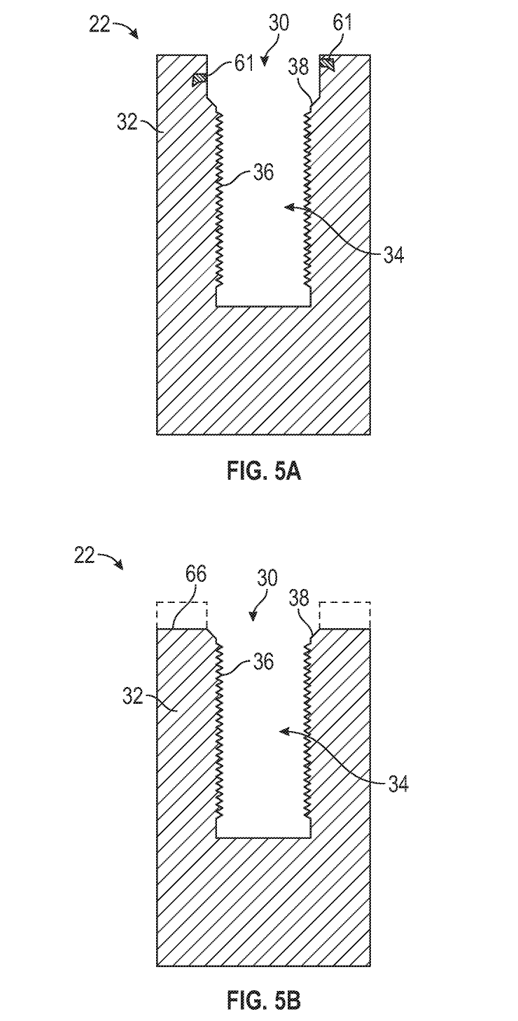

Referring now to FIG. 4, a masking plug 40 configured for use during the repair or improvement of a structure 32 adjacent a feature, such as hole 30 for example, formed in the power transmission housing 22 for example, is illustrated in more detail. The masking plug 40 illustrated in FIGS. 4-9 is typically intended for use with a countersink or counterbore hole 30. The countersink or counterbore hole 30 may include a blind hole, or alternatively, a through hole. The masking plug 40 includes a connected or integrally formed base 42, neck 44, and head 46. The base 42 of the masking plug 40 has a length less than or equal to the length of the hole portion 34 of a desired 30 and a diameter substantially equal to the diameter of the hole portion 34 (see FIG. 5a). In one embodiment, the base 42 of the masking plug 40 includes a plurality of threads 48 having a pitch diameter complementary to the threads 36 formed into the hole portion 34 such that the base 42 may threadably couple thereto.

A first end 50 of the head 46 of the plug 40 has a diameter larger than the major diameter of thread 36 of hole portion 34 and smaller than the diameter of the countersink or counterbore 30 adjacent a surface of the structure 32. The shape of the head 46 is selected to avoid interference with the cold spray deposition. In the illustrated, non-limiting embodiment, the head 46 is generally conical in shape such that the structural material applied during a deposition process is deposited evenly without the formation of pits in the final structure after the repair. The first end 50 of the head 46 is spaced apart from an adjacent end 52 of the base 42 by the neck 44. The neck 44 has a diameter less than the diameter of the base 42. The length of the neck 44 is intended to provide thread relief such that when the masking plug 40 is fully inserted, end 50 of head 46 bottoms out against a portion of the counterbore or countersink 38.

A groove 56 may be formed in a second, opposite end 54 of the head of the masking plug 40. In one embodiment, the groove 56 is generally complementary to a screw-driver to assist an operator in threadably coupling the base 42 of the plug 40 with the through hole portion 34 of the hole 30. In addition, a hole 60 extends from an end 58 of the base 42 through a portion of the interior of the plug 40. The hole 60 generally includes a threaded section 62 and a non-threaded section 64. In one embodiment, the threads (not shown) of threaded section 62 are oriented in a direction opposite the threads 36 of hole portion 34 to aid in removing the masking plug 40 from hole portion 34 after the cold spray deposition process is completed. The non-threaded section is intended to act as a pilot reference for locating the new counterbore within a required concentricity of the threads 36.

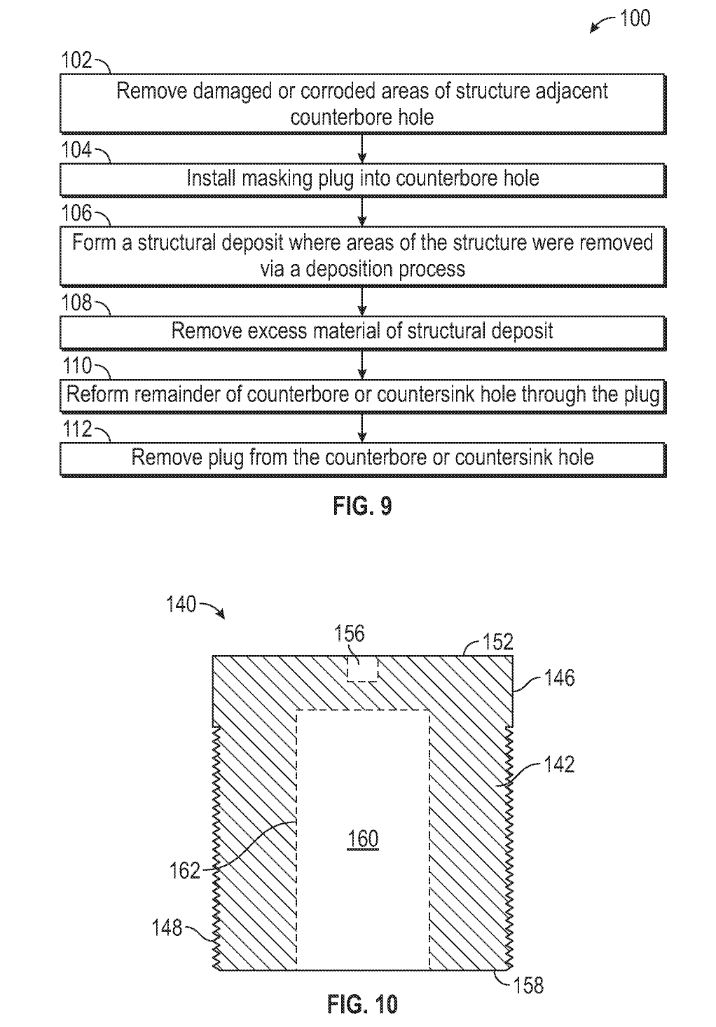

Referring now to FIGS. 5-9, a method of repairing or improving a structure 32 adjacent a hole 30 via a deposition process is illustrated and described in more detail. As shown in FIG. 5a, a portion of a structure 32, such as the transmission housing 22 for example, adjacent a hole 30 may include one or more areas 61 where damage and corrosion has already occurred or where damage and corrosion is expected or likely to occur. In block 102 of the method 100 of FIG. 9, these areas 61 of the structure 32 are removed by machining the structure 32 down to the counterbore 38, as illustrated by dotted lines in FIG. 5b. Some of the adjacent non-compromised material of the structure 32 may additionally be removed along with the areas of localized corrosion and pitting 61 to ensure that the remaining portion of the structure 32 has not been compromised. The exposed surface 66 generated as a result of this removal is generally flush with the uppermost end of the counterbore or countersink 38 of the hole 30. The areas of corrosion and pitting 61 may be removed mechanically, for example using grinding or machining, chemically, for example using etching, or via other applicable techniques.

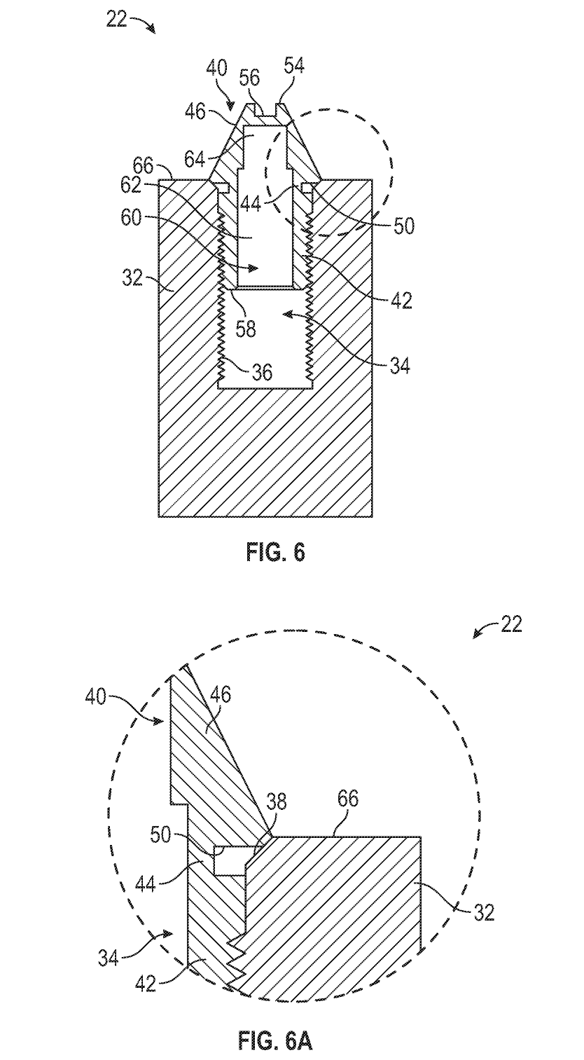

With reference now to FIGS. 6 and 6a, after the areas of localized corrosion and damage 61 are removed, the masking plug 40 is installed by threadably coupling the base 42 of the masking plug 40 to the through hole portion 34 of the hole 30, as shown in block 104. The masking plug 40 is inserted such that the circumferential edge of the first end 50 of head 46 is in contact with the countersink 38 of hole 30.

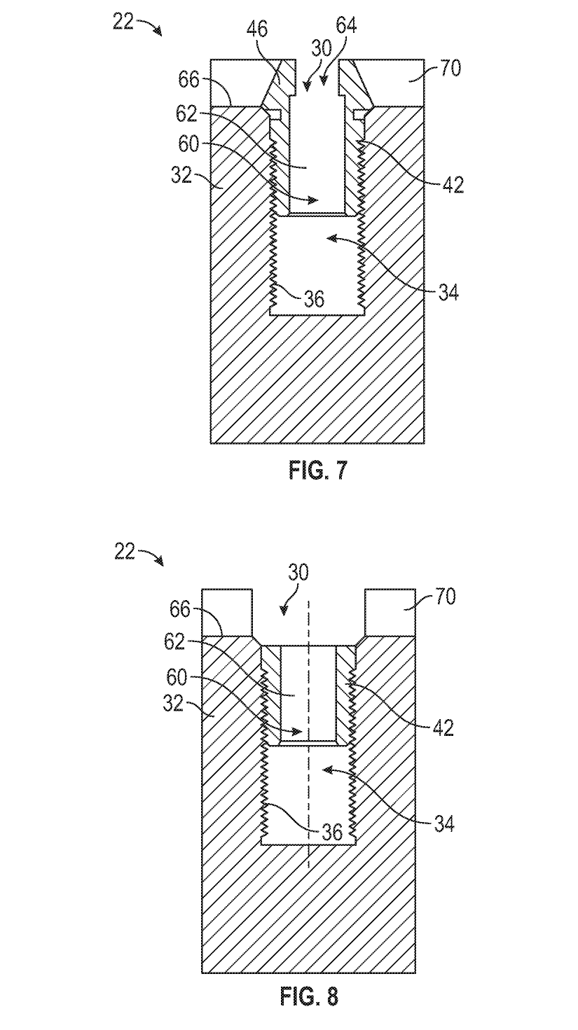

Referring now to FIG. 7 and block 106 of the method of FIG. 9, one or more layers of a powdered material are applied to the exposed surface 66 using a deposition process to create a structural deposit 70 integrally formed with the structure 32 of the housing 22. The structural deposit 70 may be formed from any suitable powdered material known in the art, such as aluminum or aluminum alloy for example. After formation, the structural deposit 70 bonded to the exposed surface 66 extends beyond the original dimensions, such as the overall height for example, of the structure 32 adjacent the hole 30. As previously stated, in one embodiment, the structural deposit 70 may be formed as a means of repairing the structure 32 after either damage (i.e. nicks, dings or gouges) or corrosion and/or pitting has already occurred, or where material of the structure is missing. In another embodiment, the structural deposit 70 is formed as a “preemptive repair” based on a determination of the areas where corrosion and pitting is most likely to occur.

As is known, the layers of powdered material used to form the structural deposit 70 are generally applied through a deposition process that provides sufficient energy to accelerate the particles to a high enough velocity such that the particles plastically deform and bond to the surface 66 and the head 46 of the masking plug 40 upon impact. The particles of the powered material are accelerated through a converging/diverging nozzle of a spray gun (not shown) to supersonic velocities using a pressurized or compressed gas, such as helium, nitrogen, other inert gases, or mixtures thereof. The deposition process does not metallurgically transform the particles from their solid state. Various techniques may be used to achieve this type of particle deposition, including but not limited to, cold spray deposition, kinetic metallization, electromagnetic particle acceleration, or modified high velocity air fuel spraying for example.

The layers of powered material may be applied to the original material of the structure 32, or alternatively, may be applied to a previously formed structural deposit 70. During deposition of the powdered material, the structure 32 may be held stationary or may be articulated or translated by any suitable means known in the art, or alternatively, the spray gun may be held stationary or may be articulated or translated. In some instances, both the structure 32 and the gun may be manipulated, either sequentially or simultaneously.

After formation of the structural deposit 70, in block 108, excess material of the structural deposits 70 are removed such that the overall height of the structure 32 is substantially identical within an allowable tolerance to its original dimension or new designed dimension as applicable per repair. During this removal process, a portion of end 54 of the head 46 of the masking plug 40 is removed to expose the non-threaded portion 64 of internal hole 60 (see FIG. 7). Using the exposed internal non-threaded portion 64 of hole 60, the central axis location of the countersink hole 30 within a required concentricity of the threads 36 of the hole portion 34 is determined. In block 110, the remainder of the hole 30 is created by machining the head 46 of the plug 40 and some portion of deposit 70. Once the hole 30 has been reformed, the base 42 of the plug 40 threadably coupled to the hole portion 34 is exposed, as shown in FIG. 8. In block 112, the remainder of the plug 40 is removed from the interior of the counterbore hole 30. To remove the base 42, a fastener (not shown), such as a bolt for example, is threadably coupled to the threaded portion 62 of internal hole 60. Alternatively, a tool, such as an easy out tool for example, can be used to extract the base 42 of the masking plug 40 by grabbing the internal thread 62 formed therein.

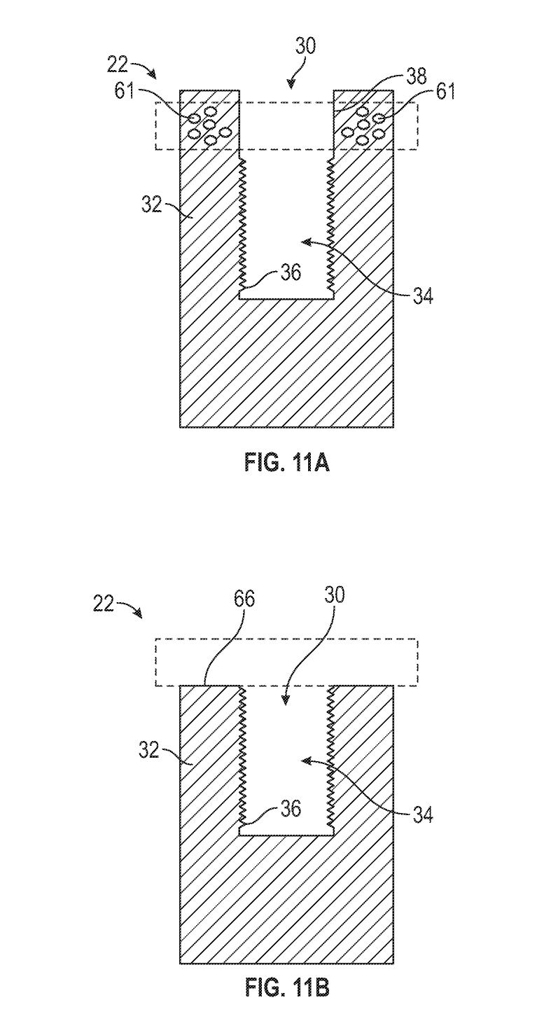

With reference now to FIGS. 10-17, another embodiment of a masking plug 140 configured for use during the repair or improvement of a structure 32 adjacent a feature, such as a simple or tapered hole 30, is illustrated in more detail. In such embodiments, the masking plug 140 includes a head 146 and a base 142. The base has a length less than or equal to the length of the hole portion 34 of a desired hole 30 and a diameter substantially equal to the diameter of the hole portion 34 (see FIG. 11a). In one embodiment, the base 142 of the masking plug 140 includes a plurality of threads 148 having a pitch diameter complementary to the threads 36 formed into the hole portion 34 such that the base 142 may threadably couple thereto.

The head 146 of the masking plug 140 is generally flat and may have a diameter than the base 142 of the masking plug 140. In the illustrated, non-limiting embodiment, the base 142 of the masking plug 140 is cylindrical, however, other shapes, such as a conical base 142 for example, are also within the scope of the disclosure. A groove 156 may be formed on top 152 of the masking plug 140. In one embodiment, the groove 156 is generally complementary to a screw-driver to assist an operator in threadably coupling the base 142 of the plug 140 with the through hole portion 34 of the hole 30. In addition, a hole 160 extends from the bottom 158 through a portion of the interior of the plug 140. An interior of the hole 160 generally includes a threaded section 162. In one embodiment, the threads (not shown) of threaded section 162 are oriented in a direction opposite the threads 36 of hole portion 34 to aid in removing the masking plug 140 from hole portion 34 after the cold spray deposition process is completed. Removal of the head 146 of the masking plug 140 is similarly required to access the hole 160 from the top 152 of the masking plug 140.

Referring now to FIGS. 11-15, a method 200 of repairing or improving a structure 32 adjacent a hole 30 via a deposition process is illustrated and described in more detail. As shown in FIG. 11a, a portion of a structure 32, such as the transmission housing 22 for example, adjacent hole 30 includes one or more areas 60 where damage and corrosion has already occurred or where damage and corrosion is expected or likely to occur. In block 202 of the method, these areas 61 of the structure 32 are removed by machining the structure 32, as previously described and as illustrated by dotted lines in FIG. 11b. Some of the adjacent non-compromised material of the structure 32 may additionally be removed along with the areas of localized corrosion and pitting 61 to ensure that the remaining portion of the structure 32 has not been compromised. The exposed surface 66 generated as a result of this removal is generally above the uppermost end of the threads 36 of hole 30. The areas of corrosion and pitting 61 may be removed mechanically, for example using grinding or machining, chemically, for example using etching, or via other applicable techniques.

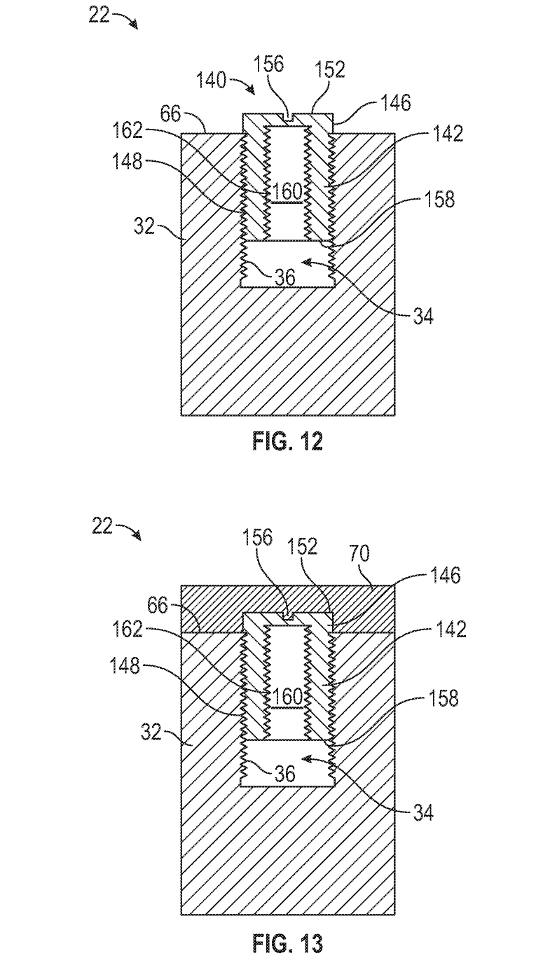

With reference now to FIG. 12 after the areas of localized corrosion and damage 61 are removed, the masking plug 140 is installed by threadably coupling the base 142 of the masking plug 140 to the through hole portion 34 of the hole 30, as shown in block 204. The masking plug 140 is inserted such that the head 146 of the masking plug 140 and the structural deposit 70 may be removed in order to access hole 160 without damaging the threads 36.

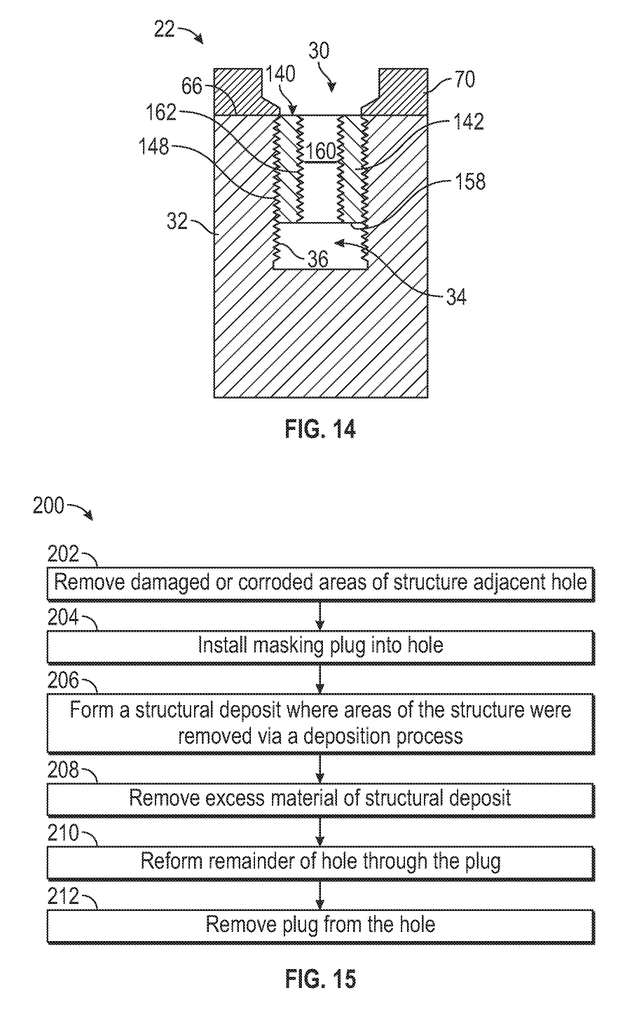

Referring now to FIG. 13 and block 206 of the method of FIG. 15, one or more layers of a powdered material are applied to the exposed surface 66 and top 152 of the masking plug 140 using a deposition process to create a structural deposit 70 integrally formed with the structure 32 of the housing 22. After formation of the structural deposit 70, in block 108, excess material of the structural deposits 70 are removed such that the overall height of the structure 32 is substantially identical within an allowable tolerance to its original dimension or new designed dimension as applicable per repair. During this removal process, at least a portion of the head 146 of the masking plug 140 is removed (see FIG. 13). In block 210, the remainder of the hole 30 is created by machining away a portion of deposit 70 and potentially some of the head 146 of the masking plug 140. Once the hole 30 has been reformed, the base 142 of the plug 140 and the interior hole 160 of the plug 140 are exposed, as shown in FIG. 14. In block 212, the remainder of the plug 140 is removed from the interior of the counterbore hole 30 as previously described.

Formation of one or more structural deposits 70 in the structure 32 of a transmission housing 22 adjacent a feature, such as a hole 30 for example, can reduce and/or prevent corrosion and pitting, thereby improving the life of the housing 22. By using the masking plug 40, 140 described herein, a portion of the hole 30 is protected while allowing for easy identification of the location of the hole 30 relative to the structural deposit 70. In addition, despite application of the structural deposit 70 directly to a portion of the masking plug 40, 140, the plug 40, 140 is easily removable from within the counterbore or countersink hole 30 upon completion.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of improving a structure of a component adjacent a feature, comprising the steps of:
removing a portion of the structure including at least one area where damage or corrosion has occurred or is likely to occur to expose a surface of the structure;
installing a masking plug into the feature such that a base of the masking plug is coupled to a first portion of the feature and a head of the masking plug is arranged adjacent a second portion of the feature;
creating a structural deposit on the surface, the structural deposit being integrally formed with the structure;
removing excess material of the structural deposit and a portion of the head of the masking plug;
reforming the second portion of feature; and
removing the masking plug from the feature.

2. The method according to claim 1, wherein an internal locating hole is exposed when removing excess material of the structural deposit and a portion of the head of the masking plug.

3. The method according to claim 1, wherein the structural deposit includes one or more layers of powdered material applied to the area through a cold spray deposition process.

4. The method according to claim 1, wherein the feature is a counterbore hole such that the first portion of the counterbore hole is a hole and the second portion of the counterbore hole is a counterbore.

5. The method according to claim 1, wherein the component is a power transmission housing of a rotary wing aircraft.

6. The method according to claim 1, wherein excess material is removed to achieve a desired dimension of the component.

7. The method according to claim 1, wherein during reforming of the second portion of the feature, the head of the masking plug is removed.

8. The method according to claim 1, wherein a tool may be coupled to a portion of the internal locating hole to remove the plug from the feature.

9. A plug for masking a feature of a component during a deposition process comprising:
a base configured to threadably couple to a first portion of the feature;
a head having a diameter smaller than a major diameter of a second portion of the feature;
a neck connecting the base and the head; and
a locating hole extending from an interior of the base to the head, the locating hole being configured to identify a location of the feature within a desired degree of concentricity.

10. The plug according to claim 9, wherein the feature is a counterbore hole such that the first portion of the counterbore hole is a hole and the second portion of the counterbore hole is a counterbore.

11. The plug according to claim 9, wherein a maximum diameter of the head is larger than a diameter of the base.

12. The plug according to claim 9, wherein a groove is formed in a free end of the head, the groove being generally complementary to a tool configured to install the plug into the feature.

13. The plug according to claim 9, wherein the locating hole includes a first portion arranged within at least the base, and a second portion arranged within the head, the first portion having a plurality of threads.

14. The plug according to claim 9, wherein the head is shaped to minimize interference with an adjacently formed structural deposit during the deposition process.

15. A plug for masking a feature of a component during a deposition process comprising:
a base configured to threadably couple to a portion of the feature;
a head having a diameter different than the base, the head being connected to the base;
a removal hole positioned within an interior of the masking plug and extending from the base over only a portion of a length of the plug, the removal hole having a plurality of threads accessible to decouple the base from the portion of the feature after formation of a structural deposit.

16. The plug according to claim 15, wherein the base is cylindrical or conical.

17. The plug according to claim 15, wherein a groove is formed in the top end of the head, the groove being generally complementary to a tool configured to install the plug into the feature.

18. The plug according to claim 15, wherein the plurality of threads of the removal hole positioned within the interior of the masking plug are oriented in a direction opposite a plurality of threads coupling the base to the portion of the feature.
